(19) United States
(12) Patent Application Publication
(10) Pub. No.: US 2007/0090049 A1
(43) Pub. Date: Apr. 26, 2007

(54) Solvent extraction process

(75) Inventors: Graham L. Hearn, Hampshire (GB); Bruce Edward Day, South Australia (AU); Bruce Wedderbum, Victoria (AU); Christopher John Wroblewski, South Australia (AU)

Correspondence Address: BRINKS HOFER GILSON & LIONE, P.O. BOX 10395, CHICAGO, IL, 60610, US

(73) Assignee: WMC RESOURCES LIMITED, VICTORIA 3006 (AU)

(21) Appl. No.: 10/553,713

(22) PCT Filed: Apr. 16, 2004
(86) PCT No.: PCT/AU04/00501

§ 371 Date: Dec. 18, 2006

(30) Foreign Application Priority Data
Apr. 16, 2003 (AU) 2003901860

(51) Int. Cl. B01D 11/04

(52) U.S. Cl. 210/634

(57) ABSTRACT

A solvent extraction process is disclosed. The process includes using an organic solvent that contains a non-ionic extractant and a conductivity enhancer that increases the electrical conductivity of the solvent to reduce build-up of static electricity in the process and thereby reduce the electrostatic discharge hazard of the solvent to an adequate fire safety level.

The present invention relates to the use of conductivity modifiers, improvers or enhancers, hereinafter referred to as “enhancers”, in solvent extraction processes.

The present invention relates particularly, although by no means exclusively, to the use of conductivity enhancers in solvent extraction processes for extracting metals, including but not limited to copper, nickel, and cobalt, from an aqueous medium using non-ionic extractants and combustible solvents.

The present invention relates more particularly, although by no means exclusively, to the use of conductivity enhancers in solvent extraction processes for extracting copper from an aqueous medium.

Large industrial processing facilities, for example solvent extraction plants, can be quite hazardous due to their size and complexity and the nature of the materials used in the plants.

Fire is a typical hazard in industrial processing facilities and the fire-safety levels of a plant can vary quite dramatically as a result of even a small change at any one or more stages in a process. A small change can also have unpredictable consequences downstream. These factors make it quite difficult to ensure fire safety is adequate at all stages in a large processing plant. Also, there can be many potential causes of fire and merely recognizing one or more of these are a problem of itself.

In basic terms, a solvent extraction process as the term is used herein is a process in which an aqueous medium containing one or more metals in solution is brought into contact with an organic solvent containing a dissolved extractant to produce an emulsion. After extraction of a specific metal from the aqueous medium into the solvent phase has taken place, the aqueous and solvent phases are separated using large settler tanks. Thereafter, the specific metal is stripped from the solvent phase. Typically, the solvent phase is re-used in the process.

Typically, solvent extraction plants include long runs of pipe work that carry a range of liquids including organic solvent, solvent containing extractant, and aqueous solutions. This range of liquids in long runs of pipe work is difficult to monitor to recognise any change which is likely to increase the potential for a fire.

The present invention is based on the realisation that build-up and discharge of static electricity in a solvent extraction process is one cause of fires in solvent extraction plants operating with non-ionic extractants and solvents at temperatures well below the flashpoints of the solvents.

The present invention is also based on the realisation that it is possible to minimise build-up and discharge of static electricity by adding conductivity enhancers to the liquids in a solvent extraction process without adversely affecting the performance of the solvent extraction process.

Accordingly, in broad terms, the present invention provides a solvent extraction process that includes operating the process using an organic solvent that contains a non-ionic extractant and a conductivity enhancer that increases the electrical conductivity of the solvent to reduce build-up of static electricity in the process and thereby reduce the electrostatic discharge hazard of the solvent to an adequate fire safety level.

In addition, in broad terms, the present invention provides an organic solvent that includes a conductivity enhancer for use in the above described solvent extraction process.

The present invention relates particularly to solvent extraction processes for metals, such as copper, which use non-ionic extractants and combustible solvents.

The term “conductivity enhancer” is understood herein to mean a reagent that can enhance the conductivity of a solvent.

The present invention was made during the course of an on-going research program on a copper solvent extraction plant that operates using a narrow-cut kerosene as the solvent at the Olympic Dam mine of the applicant. The research program has included laboratory bench trials and a mini-pilot plant continuous trial.

The term “narrow-cut kerosene” is understood herein to mean a petroleum-derived hydrocarbon solvent containing a mixture of aliphatic and aromatic hydrocarbons typically in the range of C10-C12.

Narrow-cut kerosene is flammable in the range 0.7 to 6.0% by volume with air, has a relatively high flashpoint (typically, above 75° C.), and a relatively high boiling point (typically, above 195° C.).

Kerosene is a common solvent, which is stable under normal use conditions and is used in a variety of domestic and industrial applications. These applications range from small lamps and heaters through to large-scale mining processes. Due to its relatively high flashpoint, narrow-cut kerosene is defined as a combustible solvent rather than a flammable solvent.

Based on the above properties, it is not immediately apparent that electrostatic ignition of narrow-cut kerosene would be a potential cause of fire in a solvent extraction plant operating with narrow-cut kerosene.

The research program included a series of solvent ignition trials at the University of Southampton.

The purpose of the trials was to determine the electrostatic ignition properties of narrow-cut kerosene at temperatures likely to occur in a copper solvent extraction process operated by the applicant at Olympic Dam.

The trials were restricted to the conditions and configurations possible in the copper solvent extraction process at Olympic Dam. These conditions were partially simulated using a 600 mm diameter polyethylene pipe, various types of electrostatic discharge including (a) brush, (b) propagating brush, and (c) spark, and various solvent configurations including aerosol, foam and saturated particulates. During the trials, physical parameters, such as temperature and droplet size distribution (where appropriate), were carefully monitored and the nature of the ignition and subsequent flame propagation throughout the media, when they happened, were examined.

The trials included:
(i) Ignition of a solvent-wetted pipe wall as a function of temperature with various electrostatic discharges.
(ii) Ignition of a solvent-saturated mineral deposit as a function of temperature with various electrostatic discharges.
(iii) Ignition of coarse and fine solvent aerosol from a hydraulic nozzle.
(iv) Ignition of coarse solvent droplets dispersed in a Hartmann tube apparatus.
(v) Ignition of dispersed solvent-saturated inert mineral particles sieved in order to control particle size in Hartmann tube apparatus.
(vi) Ignition of a foaming solvent on a liquid surface.

The results of the trials and electrostatic measurements on site at Olympic Dam indicated that:

(a) high levels of electrostatic charge could be generated with narrow-cut kerosene when transported through plastic and metal pipes; and

(b) the levels of charge generated at even relatively low flow velocities could, under the right conditions, result in electrostatic brush, propagating brush and spark discharges within a copper solvent extraction plant.

It was clear from the trials and the work on site at Olympic Dam that the co-existence of electrostatic discharges and particular forms of narrow-cut kerosene, such as foams and mists, creates a potential fire hazard. In particular, the trials and the work on site at Olympic Dam, demonstrated that even relatively low electrostatic discharge energies could result in an ignition which is capable of propagation through narrow-cut kerosene in foam or mist form. Once this condition is reached, the quantity and movement of fuel around a copper solvent extraction plant has the capability of producing rapid spread of a resultant fire.

In general terms, conductivity enhancers are reagents that include one or more than one active ingredient in a suitable carrier. There is a wide range of possible active ingredients and carriers. Typical carriers include toluene, kerosene, and mixtures thereof.

Preferred conductivity enhancers are reagents sold under the trade marks Stadis 425, Stadis 450, Octastat 2000, Octastat 3000, and Octastat 4065.

Stadis 425 is 10-20% toluene, 60-70% kerosene, and 2-7% solvent naphtha, and 2-8% DBSA (dodecylbenzenesulphonic acid).

Octastat 2000 is 10-20% toluene, 2-8% DBSA, 50-70% kerosene, and 2-7% trade secret (“TS”) polymer containing S.

Octastat 3000 is 40-50% toluene, 0-5% propan-2-ol, 5-15% DINNSAA (dinonylnaphthasulphonic acid), 15-30% solvent naptha, 1-10% TS polymer containing N, and 10-20% TS polymer containing S.

Stadis 450 is 50-65% toluene, 5-10% heavy aromatic naphtha, 1-10% DBSA, less than 10% benzene, 11-30% TS polymers, and less than 5% propan-2-ol.

Octastat 4065 is 30-60% kerosene, 10-30% solvent naphta, 10-30% DINNSA, 1-5% naphthalene, 1-5% propan-2-ol, and 1-5% TS polymer containing N.

The amounts of any given conductivity enhancer required to increase the conductivity of a solvent to reduce the electrostatic discharge hazard of the solvent to obtain an adequate fire safety level will depend on the target electrical conductivity of the solvent, the properties of the conductivity enhancer, and the nature of the solvent (including extractant) being enhanced.

In the case of a metal solvent extraction process, such as a copper, solvent extraction process, preferably the solvent is a narrow-cut kerosene and the extractant is an oxime which is dissolved in the narrow-cut kerosene solvent.

In the above-described particular case, preferably the amount of oxime in the narrow-cut kerosene is between 5-25% by volume of the total volume of oxime and narrow cut kerosene.

It is preferred particularly that the amount of oxime in the narrow cut kerosene be between 5-15% by volume of the total volume of oxime and narrow-cut kerosene.

In order to reduce the electrostatic discharge hazard of a solvent to obtain an adequate fire safety level, it is preferred that the electrical conductivity of the solvent in the solvent extraction process be maintained at or above 100 pS/m.

Preferably the electrical conductivity of the solvent in the solvent extraction process is maintained at or above 150 pS/m.

More preferably the electrical conductivity of the solvent in the solvent extraction process is maintained at or above 250 pS/m.

Wore preferably the electrical conductivity of the solvent in the solvent extraction process is maintained at or above 350 pS/m.

Sore preferably the electrical conductivity of the solvent in the solvent extraction process is maintained at or above 450 pS/m.

It is preferred particularly that the electrical conductivity of the solvent in the solvent extraction process be maintained at 500 pS/m.

The conductivity enhancer may be added to the solvent at any suitable stage or stages in the solvent process.

Preferably the process includes adding the conductivity enhancer to a storage tank containing the solvent for the solvent extraction process.

The conductivity enhancer may be added to the solvent in discrete doses on a periodic basis or continuously during the course of the solvent extraction process.

Preferably the solvent extraction process includes controlling the amount of the conductivity enhancer added to the process.

The conductivity enhancer may be added continuously or periodically during the course of the process in order to maintain the electrical conductivity of the solvent above a minimum level.

Preferably the solvent extraction process includes controlling the amount of the conductivity enhancer added to the process by monitoring the electrical conductivity of the solvent in the process and adjusting the amount of the conductivity enhancer added to the process to maintain the electrical conductivity above a minimum level.

The control may be by means of adjustment of the dosage rate.

Alternatively, in situations where there has been a build-up of the conductivity enhancer in the process above a desirable level, the control may be by means of reducing the concentration of the conductivity enhancer. One option in this regard is to contact the solvent with clay.

In the research program carried out by the applicant the use of conductivity enhancers to increase the conductivity of an organic solvent used in a copper solvent extraction process operated at Olympic Dam had an insignificant impact on the performance of the solvent in the process. More specifically, whilst there was an impact on plant performance in some instances, in overall terms the impact was not significant.

The time normally taken for phase separation between aqueous and solvent phases in a solvent extraction process is one measure of process performance. Phase separation takes place after a metal such as copper is extracted from an aqueous phase into an organic solvent and usually occurs in large settler tanks. The time required for phase separation impacts on the cost of the process. On the basis of the research program the applicant expects that conductivity enhancer can be added to the process under conditions that do not cause phase separation times to increase to levels that impact on operations.

The performance of the extractant used in a solvent extraction process is another measure of the performance of the process. The applicant found in the research program that extractant performance did not appear to be influenced significantly by the addition of a conductivity enhancer to the solvent.

The research program included the following laboratory bench trials, described as Examples 1 and 2, and mini-pilot plant trial that demonstrate the effect of adding conductivity enhancers to an organic solvent used in the copper solvent extraction process operated at Olympic Dam.

It is noted that the results presented in the following Examples and mini-pilot plant trial were obtained under the conditions that applied on the particular times at which the research work was carried out. The conditions included the particular compositions of the plant solvent and pregnant liquor tested and these compositions are subject to variation during standard operating conditions of a plant.

### Laboratory Bench Trials

### EXAMPLE 1

Four conductivity enhancer reagents were tested on plant solvent and pregnant liquor to assess their impact on conductivity and phase separation.

Plant samples from the Olympic Dam copper solvent extraction plant were collected in new glass bottles that had been cleaned first with hot water, then with demineralised water, and finally with heptane. No effort was made to remove entrained aqueous phase since entrainment is part of the “reality” of plant solvent.

Test samples consisting of either fresh or plant solvent containing conductivity enhancer reagents were prepared on a mass basis in glass bottles cleaned as previously stated.

Four conductivity enhancer reagents were tested, namely: Stadis 425, Stadis 450, Octastat 2000, and Octastat 3000.

For each conductivity enhancer reagent, 5 mL of the reagent was diluted to 500 mL (410.5 g) giving 10000 μL of conductivity enhancer reagent per L of stock solution. This was then diluted 20 mL to 500 mL (410.5 g) giving 400 μL/L stock solution. This was subsequently diluted 5, 10, 15 and 20 mL to 800 mL (656.8 g) giving 2.5, 5.0, 7.5 and 10.0 μL/L test solutions.

Stripped solvent from the plant was used in all dilutions.

Electrical conductivity of each test solution was measured using liquid conductivity meter model L30 supplied by the Department of Electrical Engineering, University of Southampton.

Phase separation times were determined by measuring 400g pregnant liquor solution (“PLS”) and 328.4 g (400 mL) solvent into a baffled one litre beaker. Beaker markings were used to place the agitator in a similar position for each test. After agitation at 300 rpm for 2 minutes the time for the phase separation to reach 200 mL, 300 mL and 350 mL for each sample was recorded.

Results

Unenhanced solvent had a conductivity of 40 pS/m, while conductivity data for enhanced solvent is shown in Table 1.

TABLE 1
Conductivity (pS/m) of enhanced copper
solvent at various concentrations.

| | Reagent Concentration | | | |
|---|---|---|---|---|
| Reagent | 2.5 μL/L | 5.0 μL/L | 7.5 μL/L | 10.0 μL/L |
| Stadis 425 | 100 | 140 | 240 | 300 |
| Stadis 450 | 130 | 260 | 410 | 590 |
| Octastat 2000 | 80 | 150 | 240 | 320 |
| Octastat 3000 | 170 | 360 | 550 | 720 |

In terms of conductivity improvement, it is apparent that Octastat 3000 conductivity enhancer was significantly better than any of the other enhancers.

Phase separation measurements are set out in Table 2.

TABLE 2
Phase separation times (minutes) for various
mixtures (S = Stadis, O = Octastat)

| | | | | 10 | 10 | 10 | 7.5 | 10 |
|---|---|---|---|---|---|---|---|---|
| | Unenhanced | | | μL/L | μL/L | μL/L | μL/L | μL/L |
| Separation | Solvent | | | S425 | S450 | O2000 | O3000 | O3000 |
| 200 mL | 20 | 18 | 20 | 20 | 20 | 19 | 20 | 21 |
| 300 mL | 33 | 32 | 36 | 37 | 37 | 35 | 34 | 35 |
| 350 mL | — | 53 | 55 | 55 | 56 | 52 | 51 | 55 |

It is evident from Table 2 that there was no statistical difference in phase separation between samples without conductivity enhancers and samples with conductivity enhancers at concentrations targeting 500 pS/m conductivity.

Conclusions

The above results indicate that conductivity enhancers had very little effect on phase separation.

### EXAMPLE 2

Two conductivity enhancer reagents were added at various concentrations to plant solvent (Shellsol™ narrow-cut kerosene) containing copper extractants (Acorga oxime or LIX oxime). The resultant solutions were loaded and stripped with pregnant plant liquor to assess the impact of these process steps on conductivity and phase separation.

Method

The method of preparing solutions containing plant solvent and standard additions of conductivity enhancer reagent was essentially the same as in Example 1, except that fresh Shellsol narrow-cut kerosene was used in all dilutions, and the samples were prepared on a volume basis (using volumetric flasks) rather than on a mass basis.

Anything in contact with solvent was cleaned using hot water, demineralised water, and then heptane. Cleanliness was checked by measuring the conductivity of the final wash of heptane, which had to be less than 5 ps/M.

A bulk Acorga oxime solution containing 10% v/v Acorga oxime in fresh Shellsol narrow-cut kerosene was prepared and then conditioned by shaking with strong electrolyte at a ratio of 2.5:1 and then discarding the electrolyte.

A bulk LIX oxime solution containing 10% v/v LIX oxime in fresh Shellsol narrow-cut kerosene was prepared and then conditioned by shaking with strong electrolyte at a ratio of 2.5:1 and then discarding the electrolyte.

For each conductivity enhancer reagent (Stadis 450 and Octastat 3000), 5 mL was diluted to 100 mL giving 50000 μL conductivity enhancer reagent per L of stock solution. This was then diluted 5 mL to 250 mL giving 1000 μL/L stock solution. This was subsequently diluted: (a) 5, 10, 15 and 20 μL to 1 litre of plant solvent, (b) 5, 10, 15 and 20 μL to 1 litre of fresh 10 % Acorga oxime solution, and (c) 5, 10, 15 and 20 μL to 1 litre of fresh 10 % LIX solution, giving 5, 10, 15 and 20 μL/L test solutions.

In each test run, a 2000 mL beaker with baffles was loaded with 1000 mL PLS and 500 mL test solution. The mixture was agitated for 5 minutes, and the time taken for separation to a mark on the beaker just below 1000 mL was recorded.

After loading, the entire contents were transferred to a 2 L separation funnel and the raffinate was discarded after collection of sample for analysis. Conductivity of a portion of the test solution was measured, and 400 mL collected for stripping using a measuring cylinder. Remaining test solution was used for analysis.

The test solution was transferred to a 1 L glass bottle, and 160 mL weak electrolyte added. An agitator with hinged blades was inserted into the bottle and the concoction was then mixed at 400 rpm for 5 minutes. Separation times were initially recorded, but the reliability and usefulness was very poor because bubble formation around the interface made it very difficult to get reproducible times.

For the test involving multiple loading/stripping, exactly the same procedure was used, but because of solvent lost through sample collection and entrainment, replicate loading/stripping tests were combined at each stage so that there would be sufficient test solution left for the final load/strip. The sequence is shown in Table 3.

TABLE 3
Loading and stripping volumes for multi-stage extractions.

| Cycle | Load | Strip |
|---|---|---|
| 1 | 5 × 500 mL = 2500 mL | 5 × 400 mL = 2000 mL |
| 2 | 3 × 500 mL = 1500 mL | 3 × 400 mL = 1200 mL |
| 3 | 2 × 500 mL = 1000 mL | 2 × 400 mL = 800 mL |
| 4 | 1 × 500 mL = 500 mL | 1 × 400 mL = 400 mL |

Results

Tables 4 and 5 present electrical conductivity and phase separation times for loaded and stripped test solutions containing added enhancers. Table 6 highlights the change in electrical conductivity as test solutions were loaded and stripped a number of times.

TABLE 4
Conductivity (nS/m) of copper solvent from
various sources with added conductivity.

| | Enhancer | Octastat 3000 | | | Stadis 450 | | |
|---|---|---|---|---|---|---|---|
| Solvent | Concentration | Conductivity (nS/m) | | | Conductivity (nS/m) | | |
| Source | μL/L | Start | Loaded | Stripped | Start | Loaded | Stripped |
| Plant stripped | 0 | 0.08 | 0.03 | 0.02 | — | — | — |
| Solvent | 5 | 0.53 | 0.52 | 0.53 | 0.39 | 0.41 | 0.32 |
| | 10 | 1.07 | 1.06 | 1.18 | 0.88 | 0.82 | 0.77 |
| | 15 | 2.00 | 2.32 | N/A | 1.72 | 1.62 | 1.12 |
| | 20 | 3.03 | 2.88 | 1.55 | 2.72 | 2.26 | 1.26 |
| 10% v/v Acorga | 0 | 0.04 | N/A | N/A | — | — | — |
| in Shellsol | 5 | 0.46 | 0.38 | 0.32 | 0.30 | 0.50 | 0.52 |
| | 10 | 0.86 | 0.76 | 0.65 | 0.64 | 0.89 | 0.67 |
| | 15 | 1.19 | 1.14 | 1.25 | 0.94 | 1.71 | 0.90 |
| | 20 | 1.69 | 2.49 | 1.96 | 1.21 | 2.55 | 1.20 |
| 10% v/v LIX | 0 | 0.13 | 0.04 | 0.10 | — | — | — |
| in Shellsol | 5 | 0.69 | 0.56 | 0.81 | 0.53 | 0.48 | 0.47 |
| | 10 | 1.00 | 1.02 | 1.21 | 0.62 | 0.91 | 0.89 |
| | 15 | 1.41 | 1.65 | 1.77 | 1.17 | 1.43 | 1.24 |
| | 20 | 1.93 | 2.63 | 2.17 | 1.59 | 1.72 | 1.77 |

TABLE 5
Phase separation times for various mixtures.

| | Enhancer | | | | |
|---|---|---|---|---|---|
| | Concentra- | Octastat 3000 | | Stadis 450 | |
| Solvent | tion | Separation Time(s) | | Separation Time(s) | |
| Source | μL/L | Loading | Stripping | Loading | Stripping |
| Plant | 0 | 60 | 67 | — | — |
| stripped | 5 | 65 | 75 | 68 | 75 |
| Solvent | 10 | 66 | 78 | 70 | 51 |
| | 15 | 76 | N/A | 76 | 68 |
| | 20 | 71 | 94 | 71 | 90 |
| 10% v/v | 0 | N/A | N/A | — | — |
| Acorga in | 5 | 60 | 115 | 68 | 75 |
| Shellsol | 10 | 68 | 115 | 68 | 95 |
| | 15 | 72 | 105 | 75 | 100 |
| | 20 | 77 | 95 | 48 | N/A |
| 10% v/v | 0 | 46 | N/A | — | — |
| LIX in | 5 | 51 | N/A | 48 | N/A |
| Shellsol | 10 | 49 | N/A | 46 | N/A |
| | 15 | 47 | N/A | 55 | N/A |
| | 20 | 48 | N/A | 50 | N/A |

TABLE 6
Conductivity of 16 μL/L Octastat 3000 in plant solvent.

| | Conductivity (nS/m) | | |
|---|---|---|---|
| Cycle | Start | Load | Strip |
| 1 | 1.80 | 1.18 | 0.96 |
| 2 | — | 0.99 | 0.98 |
| 3 | — | 0.95 | 0.96 |
| 4 | — | 0.89 | 0.76 |

### Conclusions

In terms of electrical conductivity enhancement, Octastat 3000 performed better than Stadis 450 by about 20 to 30%. In addition, multiple loading and stripping of the test solutions resulted in a decrease in conductivity at an apparently modest rate after an initial drop in conductivity.

Mini-pilot Plant Trials

In addition to the above laboratory bench trials, the research program included a mini-pilot plant continuous trial carried out by ANSTO.

The purpose of the trial was to test the impact of conductivity enhancer addition on mini-pilot plant performance.

The mini-plant circuit was set up to simulate as closely as possible operating conditions in the copper solvent extraction plant at Olympic Dam.

Two circuits, CIRCUIT 1 (C1) and CIRCUIT 2 (C2), with identical configurations, were operated in parallel.

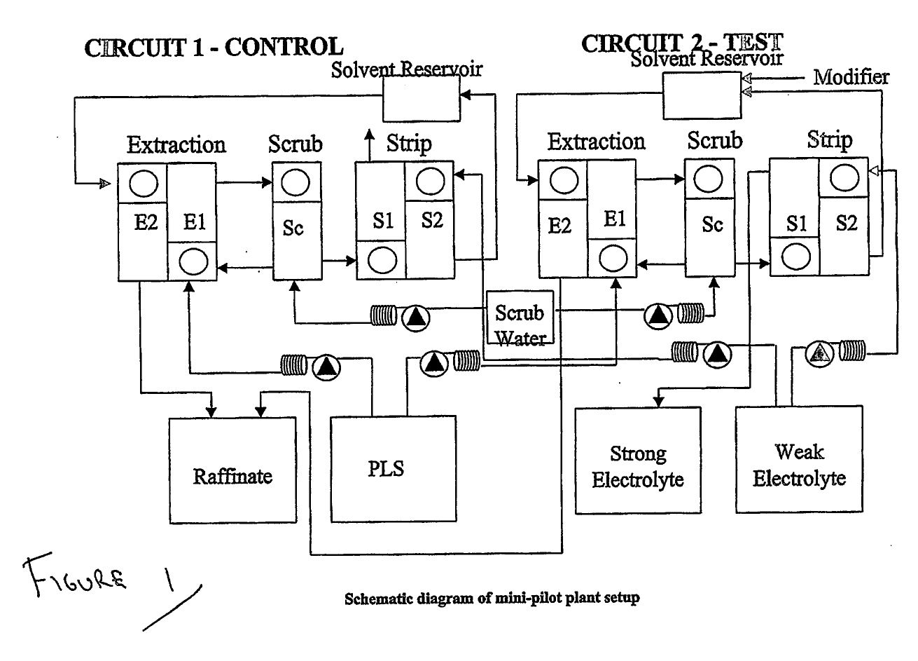

Each circuit consisted of 2 extraction stages, 1 scrub stage and 2 strip stages. The aqueous feed solutions were heated prior to entering the circuits via glass coils immersed in a water bath. A schematic representation of the set-up is shown in FIG. 1.

CIRCUIT 1 was operated without a conductivity enhancer reagent and CIRCUIT 2 was operated with a conductivity enhancer reagent.

The details of operating conditions for CIRCUIT 2 are summarised in Table 7 below. The conductivity enhancer reagent used for this work was Octastat 3000. It was added to the circuit as a 5000 μL/L solution diluted in Shellsol 2046 narrow cut kerosene.

TABLE 7
Summary of Mini-pilot plant Operating Conditions

| | | RUN 1 | RUN 1 |
|---|---|---|---|
| | | Enhancer | Enhancer & Clay Treatment |
| | | 20-144 h | 144-240 h |
| O:A flows | Extraction | 1.0 | 1.0 |
| | Scrub | 17 | 16 |
| | Strip | 6.4 | 3.9 |
| Mixer | Extraction | 1.6 | 1.7 |
| Retention | Scrub | 1.3 | 1.3 |
| (min.) | Strip | 1.2 | 1.3 |
| Settler Load* | Extraction | 4.2 | 4.0 |
| (m³/h/m²) | Scrub | 4.2 | 4.0 |
| | Strip | 4.3 | 4.0 |
| Temperature | | 45-31 | 47-35 |

*Mini-pilot plant settler loads calculated using barriers to reduced effective settler size to ¼ of its total size

CIRCUIT 1 was the control circuit and CIRCUIT 2 was the test circuit.

The mini-pilot plant was operated for 240 hours. After 144 h, clay treatment was introduced in both the control and the test circuits.

Electrical conductivity, phase separation times and other measurements were made during the operation of 5 the mini-pilot plant.

The objective of conductivity enhancer addition to the mini-pilot plant circuit was to increase the conductivity of the solvent in the circuit to a target of 500 pS/m. This target level had been determined from laboratory bench trials to be a very safe level in terms of preventing a build-up and discharge of static electricity, and therefore significantly contributing to reducing the risk of a fire.

The two circuits were set up with solvent being pumped from the reservoirs to the extraction circuits, and stripped solvent being returned to the reservoirs. Frequent samples were taken from the reservoirs and the conductivity measured with liquid conductivity meters (Wolfson Electrostatics, Model 30). Periodically, solvent samples were also taken from the settlers of the extraction, scrub and strip circuits. All samples were returned to the circuits.

Baseline electrical conductivity data was obtained by measurements of solvent samples taken from CIRCUIT 1 (the control circuit) operated without any conductivity enhancer. The results indicated that, on average, the conductivity of the solvent reservoir in the control circuit was 35 pS m⁻¹, with similar values measured in the strip circuit. The readings of samples taken from the extraction and scrub circuits were higher than that of the reservoir, with maximum readings of 83 and 101 pS m⁻¹ measured for the two circuits, respectively.

The electrical conductivity of the reservoir of the test circuit, CIRCUIT 2, was also similarly monitored.

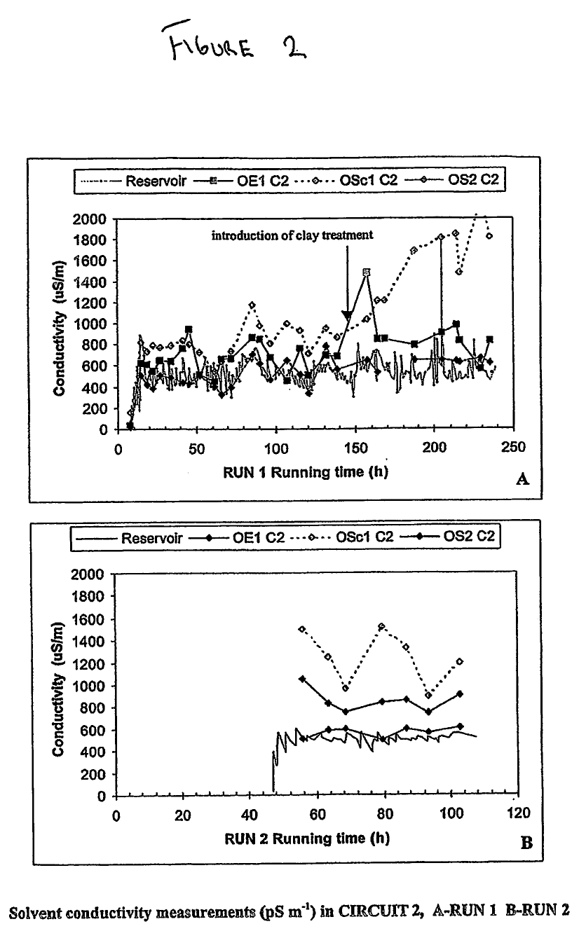

Addition of small volumes of conductivity enhancer (0.2-1 mL at a time) was made to the reservoir to aim for a target conductivity of 500 pS m⁻¹. A stock of 5000 μL/L of enhancer in Shellsol 2046 narrow-cut kerosene was used for this purpose. The stock solution was kept in the dark, when not in use. Conductivity enhancer was added to CIRCUIT 2 throughout RUN 1. For RUN 2, conductivity enhancer addition to CIRCUIT 2 only commenced 48 hours after the start of the run. Conductivity measurements of samples taken from the reservoir extraction, scrub and strip circuits are shown in FIG. 2.

The conductivity measurements consistently showed higher values for extraction, and even higher values for scrub solvent samples. The conductivity of the solvent in the strip circuit was similar to that of the reservoir. This observation was consistent for both RUN 1 and RUN 2. In RUN 1, introduction of clay treatment increased the difference between reservoir and scrub solvent conductivities with readings as high as 2000 pS m⁻¹ registered. In RUN 2, where there was no clay treatment, conductivity values for scrub varied between 1000-1600 pS m⁻¹.

Conclusions

No major differences in phase disengagement characteristics were detected between operation with and without conductivity enhancer Octastat 3000 doped to a target conductivity of 500 pS/m in the solvent reservoir.
The presence of conductivity enhancer did not cause any increase in the measured organic entrainment levels in both the raffinate and strong electrolyte solutions. The amount of organic entrainment averaged between 25-140 ppm in the raffinate and between 19-28 ppm in the strong electrolyte.
The presence of conductivity enhancer did not cause any increase in aqueous entrainment in the loaded organic, which averaged at 0.05%.
The presence of conductivity enhancer did not increase the amount of impurity carry-over to the strong electrolyte.
The measured plant data showed that addition of conductivity enhancer increased copper extraction. The increase was quite significant (˜12%) from a baseline of 55-59%.
The presence of conductivity enhancer consistently resulted in higher levels of conductivity in the scrub and extraction circuits compared to the strip circuit and solvent reservoir. This increase could not be attributed to aqueous entrainment in the solvent or the formation of stable emulsions.

The overall assessment of the mini-pilot plant trial is that addition of Octastat 3000 to a target conductivity of 500 pS/m did not have a short term negative impact on copper solvent extraction and, moreover, caused a significant increase in copper extraction.

Many modifications may be made to the embodiments of the present invention described above without departing from the spirit and scope of the invention.

1. A solvent extraction process that includes operating the process using an organic solvent that contains a non-ionic extractant and a conductivity enhancer that increases the electrical conductivity of the solvent to reduce build-up of static electricity in the process and thereby reduce the electrostatic discharge hazard of the solvent to an adequate fire safety level.

2. The process defined in claim 1 includes adding conductivity enhancer continuously or periodically during the course of the process and maintaining the electrical conductivity of the solvent above a minimum level.

3. The process defined in claim 2 includes controlling the amount of the conductivity enhancer added to the process by monitoring the electrical conductivity of the solvent in the process and adjusting the amount of the conductivity enhancer added to the process to maintain the electrical conductivity above a minimum level.

4. The process defined in claim 1 for extracting a metal, such as copper, includes maintaining the electrical conductivity of the solvent at or above 100 pS/m.

5. The process defined in claim 4 includes maintaining the electrical conductivity of the solvent at or above 150 pS/m.

6. The process defined in claim 5 includes maintaining the electrical conductivity of the solvent at or above 250 pS/m.

7. The process defined in claim 6 includes maintaining the electrical conductivity of the solvent at 350 pS/m.

8. The process defined in claim 7 includes maintaining the electrical conductivity of the solvent at 500 pS/m.

9. The process defined in claim 1 wherein the conductivity enhancer is a reagent that contains 10-20% toluene, 60-70% kerosene, and 2-7% solvent naphtha, and 2-8% DBSA (dodecylbenzenesulphonic acid).

10. The process defined in claim 2, wherein the conductivity enhancer is a reagent that contains 10-20% toluene, 2-8% DBSA, 50-70% kerosene, and 2-7% TS polymer containing S.

11. The process defined in claim 2, wherein the conductivity enhancer is a reagent that contains 40-50% toluene, 0-5% propan-2-ol, 5-15% DINNSAA (dinonylnaphthasulphonic acid), 15-30% solvent naptha, 1-10% TS polymer containing N, and 10-20% polymer containing S.

12. The process defined in claim 2, wherein the conductivity enhancer is a reagent that contains 50-65% toluene, 5-10% heavy aromatic naphtha, 1-10% DBSA, less than 10% benzene, 11-30% TS polymers, and less than 5% propan-2-ol.

13. The process defined in claim 2, wherein the conductivity enhancer is a reagent that contains 30-60% kerosene, 10-30% solvent naphta, 10-30% DINNSA, 1-5% naphthalene, 1-5% propan-2-ol, and 1-5% TS polymer containing N.

14. The process defined in claim 1 wherein the organic solvent is a narrow-cut kerosene and the extractant is an oxime which is dissolved in the solvent and the amount of oxime is between 5-25% by volume of the total volume of oxime and narrow cut kerosene.

15. The process defined in claim 14 wherein the amount of oxime in the narrow cut kerosene is between 5-15% by volume of the total volume of oxime and narrow cut kerosene.

16. An organic solvent for extracting a metal, such as copper, from an aqueous medium in a solvent extraction process, which solvent includes a combustible organic solvent, such as a narrow-cut kerosene, a non-ionic extractant, and a conductivity enhancer, and the conductivity enhancer is a reagent that contains 10-20% toluene, 60-70% kerosene, and 2-7% solvent naphtha, and 2-8% DBSA (dodecylbenzenesulphonic acid).

17. An organic solvent for extracting a metal, such as copper, from an aqueous medium in a solvent extraction process, which solvent includes a combustible organic solvent, such as a narrow-cut kerosene, a non-ionic extractant, and a conductivity enhancer, and the conductivity enhancer is a reagent that contains 10-20% toluene, 2-8% DBSA, 50-70% kerosene, and 2-7% TS polymer containing S.

18. An organic solvent for extracting a metal, such as copper, from an aqueous medium in a solvent extraction process, which solvent includes a combustible organic solvent, such as a narrow-cut kerosene, a non-ionic extractant, and a conductivity enhancer, and the conductivity enhancer is a reagent that contains 40-50% toluene, 0-5% propan-2-ol, 5-15% DINNSAA (dinonylnaphthasulphonic acid), 15-30% solvent naptha,1-10% TS polymer containing N, and 10-20% polymer containing S.

19. An organic solvent for extracting a metal, such as copper, from an aqueous medium in a solvent extraction process, which solvent includes a combustible organic solvent, such as a narrow-cut kerosene, a non-ionic extractant, and a conductivity enhancer, and the conductivity enhancer is a reagent that contains 50-65% toluene, 5-10% heavy aromatic naphtha, 1-10% DBSA, less than 10% benzene, 11-30% TS polymers, and less than 5% propan-2-ol.

20. An organic solvent for extracting a metal, such as copper, from an aqueous medium in a solvent extraction process, which solvent includes a combustible organic solvent, such as a narrow-cut kerosene, a non-ionic extractant, and a conductivity enhancer, and the conductivity enhancer is a reagent that 30-60% kerosene, 10-30% solvent naphta, 10-30% DINNSA, 1-5% naphthalene, 1-5% propan-2-ol, and 1-5% TS polymer containing N.
